(19) United States
(12) Patent Application Publication
(10) Pub. No.: US 2005/0289222 A1
(43) Pub. Date: Dec. 29, 2005

(54) Flexible session initiation protocol endpoint signaling

(76) Inventor: Faramarz F. Sahim, Boca Raton, FL (US)

Correspondence Address: Siemens Corporation;Intellectual Property Department, 170 Wood Avenue South, Iselin, NJ, 08830, US

(21) Appl. No.: 10/879,565

(22) Filed: Jun. 28, 2004

(51) Int. Cl. G06F 15/16

(52) U.S. Cl. 709/206

(57) ABSTRACT

A method, apparatus, and computer program product for flexibly assigning Session Initiation Protocol (SIP) Endpoints to any part of a communication resource is disclosed. The present invention removes the device location and behavior requirements from the application, thus providing a generic interface for robust application development.

### FIELD OF THE INVENTION

The present invention relates generally to the Session Initiation Protocol (SIP). More particularly, the present invention relates to a method, apparatus, and computer program for assigning a plurality of SIP Endpoints to any part of a communication resource that participates in SIP based sessions.

### BACKGROUND OF THE INVENTION

The Session Initiation Protocol (SIP) is an application-layer control protocol for creating, modifying, and terminating sessions between communication resources. The SIP protocol specification is defined in the Internet Engineering Task Force (IETF) Request for Comments (RFC) 3261, dated June 2002; the disclosure of which is incorporated herein by reference in its entirety. Accordingly, it is known in the art that SIP may be used by a SIP Enabled Application, which is executing on a SIP Enabled Device, to manage Internet telephony and distributed multimedia conferencing sessions.

The SIP protocol specification defines several types of communication resources that are involved in establishing and maintaining SIP based sessions, which can include user agents, registrars, redirect servers, and proxies. These SIP communication resources are responsible for sending, receiving, routing, and relaying SIP messages among various user agents that participate in SIP based sessions.

A SIP Endpoint is a logical construct in a communication resource that participates in a SIP based session. A SIP Endpoint is assigned a SIP Universal Resource Identifier (URI) to enable communications with other SIP communication resources. The SIP URI identifies a sender and a receiver of a SIP message in the header fields of SIP protocol data units.

According to the SIP specification, RFC 3261, the general format of a SIP URI is: “sip:user@host.” There also several optional fields of a SIP URI. A SIP URI is similar to the popular mailto URL that defines an email address. The SIP specification also defines a SIPS URI, which indicates that a communication resource is to be contacted securely. The SIPS URI has the same general format as the SIP URI format shown above, except the term “sip” is replaced with “sips”. The term “SIP address” will be used throughout this specification to refer in general to either a SIP URI or a SIPS URI, as will be understood.

A physical endpoint in a SIP network is a SIP Enabled Device or object. Examples of SIP Enabled Devices include, but are not limited to, a telephone, a personal computer, a personal digital assistant, and a multimedia teleconferencing device. These SIP Enabled Devices employ SIP Enabled Applications to establish and maintain sessions that are required by the SIP Enabled Applications.

Prior art SIP Enabled Applications associate a single SIP Endpoint with a single SIP Enabled Device. As a result, current SIP Enabled Applications only have the capability to provide limited control of subscriber devices, which limits the features and services that may be provided by these applications. For example, current SIP Enabled Applications that support Internet telephony are unable to offer many of the advanced features that are currently available to users of non-SIP enabled devices, who connect to the Public Switched Telephone Network (“PSTN”) through a Private Branch Exchange (PBX). These advanced features include, but are not limited to, three-way calling and advanced display control.

Prior art SIP enabled Internet telephony systems have attempted to overcome the above-mentioned limitations of SIP by implementing additional protocols in conjunction with SIP. These protocols have provided a subset of the features currently available to modern PBX users, such as the capability to signal a new incoming call on a SIP Enabled Device that is already part of a SIP communication session, for example. However, these protocols are not flexible and are limited in scope and applicability. Moreover, these protocols do not provide an optimized SIP call flow. Applications developed in conjunction with these protocols do not provide the flexibility of associating multiple SIP Endpoints with a single SIP Enabled Device.

### SUMMARY AND OBJECTS OF THE INVENTION

The foregoing and other problems and deficiencies in the prior art are overcome by the present invention that provides a method, apparatus, and computer program for flexibly assigning multiple SIP Endpoints to a single subscriber SIP Enabled Device.

An object of the present invention is to remove device location and behavior requirements from a SIP Enabled Application, thus providing a generic interface for developing robust SIP Enabled Applications.

A further object of the present invention is to provide SIP Enabled Applications with an ability to associate and coordinate activities that are occurring on a plurality of SIP Endpoints, which endpoints may correspond to any part of a SIP Enabled Device.

Yet another object of the present invention is to enable the development of advanced features in SIP Enabled Applications.

Still another object of the present invention is to provide the ability to develop powerful SIP call control applications.

A further object of the present invention is to expose all User Interface Points of a communication resource to SIP Enabled Applications.

An additional object of the present invention is to provide administrators of SIP Enabled Applications with the flexibility to define where and how SIP calls are handled.

Yet another object of the present invention is that it allows every SIP subscriber to receive notification of calls on multiple SIP Endpoints.

Still additional object of the present invention is to allow SIP Endpoints to have implicit associations with subscribers.

An additional object of the present invention is to allow subscribers to define the behavior of SIP Endpoints based on call situations.

### BRIEF DESCRIPTION OF THE DRAWINGS

The foregoing objects are achieved and other features and advantages of the present invention will become more apparent in light of the following detailed description of exemplary embodiments thereof, as illustrated in the accompanying drawings, where:

FIG. 1 depicts a block diagram of a typical prior art SIP Enabled Device.

FIG. 2 depicts a diagram of a user interface of a typical prior art SIP Enabled Device used in Internet telephony applications.

FIG. 3 depicts a network diagram with two SIP Enabled Devices, whose User Interface is show in FIG. 2, connected to a network for use in an SIP enabled Internet telephony application.

FIG. 4 depicts a sample of SIP message traffic in the network of FIG. 3.

FIG. 5 depicts a block diagram of an exemplary SIP Enabled Device according to the present invention.

FIG. 6 depicts a diagram of a User Interface of an exemplary SIP Enabled Device of the present invention.

FIG. 7 depicts pseudo code representing the functionality of an exemplary SIP Endpoint Guardian of the present invention.

FIG. 8 depicts a block diagram of the exemplary SIP Enabled Device, whose User Interface is shown in FIG. 6.

FIG. 9 shows interactions of the exemplary SIP Endpoint Guardian shown in FIG. 8.

FIG. 10 depicts a sample of messages that are exchanged between two of the exemplary SIP Enabled Devices of FIG. 8, when connected to the network of FIG. 3.

FIG. 11 depicts a User Interface of an exemplary SIP Enabled Device of the present invention.

FIG. 12 depicts a block diagram of a subset of a SIP Enabled Device, whose User Interface is shown in FIG. 11.

FIG. 13 depicts a sample of messages that are exchanged between two of the SIP Enabled Devices of FIG. 12, when connected to the network of FIG. 3.

### DETAILED DESCRIPTION

Generally, under the present invention, users or subscribers of SIP Enabled Applications are able to enjoy advanced features not available in the prior art. A user of a SIP Enabled Device of the present invention enjoys advanced features currently available to users of modern non-SIP based PBX systems. A SIP Enhanced Device of the present invention employs a plurality of SIP Endpoints, thus providing SIP Enabled Applications with the flexibility to coordinate and control multiple aspects of communication resources. Examples of SIP Enabled Devices include telephones, personal computers, and multimedia conferencing systems.

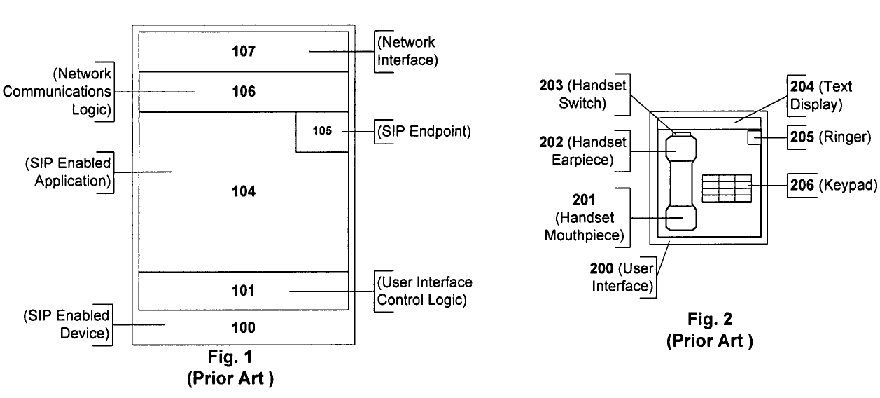

The present invention will now be described in detail with reference to the accompanying drawings. Referring to FIG. 1, a prior art SIP Enabled Device 100 is logically comprised of User Interface Control Logic 101 that interfaces with a user interface (not shown). The User Interface Control Logic 101 also interfaces with a SIP Enabled Application 104. The SIP Enabled Application 104 interfaces with a single SIP Endpoint 105 to send and receive SIP messages (not shown). The SIP Enabled Application 104 also interfaces with Network Communications Logic 106 to send and receive non-SIP messages (not shown). The Network Communications Logic 106 implements communications protocols that are required to communicate with other network resources. Network Communications Logic 106 interfaces with Network Interface 107, which is used to physically interface to a network (not shown) that provides connectivity with other SIP Enabled Devices.

FIG. 2 shows an example of a simple User Interface 200 of a prior art SIP Enabled Device that is used for Internet telephony applications. User Interface 200 is comprised of components including: handset mouthpiece 201, handset earpiece 202, handset switch 203, text display 204, ringer 205, and keypad 206. A user (not shown) physically manipulates the User Interface 200 components to operate the SIP Enabled Device in a manner that is similar to a conventional telephone.

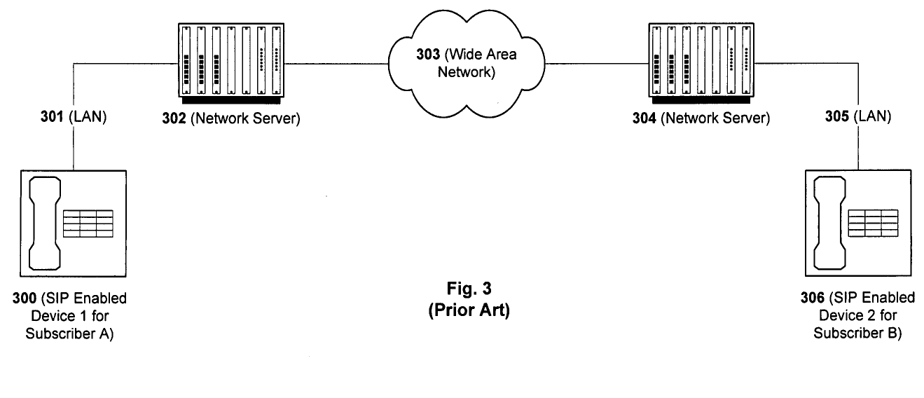

FIG. 3 depicts a network diagram illustrating how SIP Enabled Devices may be physically connected. In this example, subscriber A's SIP Enabled Device 300 is connected to a Local Area Network (LAN) 301. LAN 301 is connected to Network Server 302, which is also connected to Wide Area Network 303. Wide Area Network 303 is also connected to Network Server 304. Network Server 304 is connected to LAN 305, which is also connected to subscriber B's SIP Enabled Device 306. For illustrative simplicity, Network Servers 302 and 304 each perform the function of a SIP Proxy Server, a SIP Redirect Server, and a SIP Registrar; the functionality of which are defined in the SIP protocol specification. These Network Servers also contain additional functionality that is required for the SIP Enabled Devices to communicate; for example a Domain Name System (DNS) server, a Dynamic Host Control Protocol (DHCP) server, and a Lightweight Directory Access Protocol (LDAP) server.

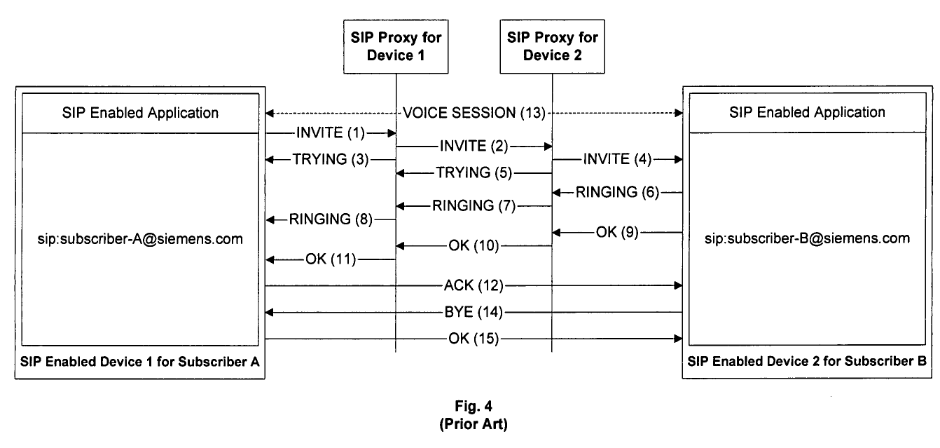

FIG. 4 depicts a typical exchange of data messages during a SIP session. The SIP session shown results from subscriber A initiating a voice call to subscriber B. For illustrative simplicity, only the SIP Enabled Application and SIP Endpoint for each SIP Enabled Device are shown. Prior to placing the voice call, subscriber A has configured the SIP Endpoint in her SIP Enabled Device with a SIP address of “sip:subscriber-A@siemens.com” and subscriber B has configured the SIP Endpoint in her SIP Enabled Device with a SIP address of “sip:subscriber-B@siemens.com.” During the SIP session, each SIP Enabled Application uses these SIP addresses to communicate with each other to coordinate voice call data that is exchanged by the SIP Enabled Applications. For example, subscriber A's SIP Enabled Application communicates with subscriber B's SIP Enabled Application by inserting “sip:subscriber-B@siemens.com” into the “To” header field of a SIP message.

The convention used throughout this specification is that a SIP message is shown as a solid line with a single arrow, which indicates the direction of message transmission. The type of SIP message is indicated on the line along with a number in parentheses, which indicates the relative ordering of messages. For example, the line containing “INVITE (1)” is a solid line, so it is a SIP message. Furthermore, it is a SIP Invite message and it is the first message that is sent in the exchange of messages depicted. This SIP message is sent from the SIP Endpoint in subscriber A's SIP Enabled Device to subscriber A's SIP Proxy. Non-SIP messages are shown as a dashed line. For example, the dashed line with “VOICE SESSION (13)” indicates that non-SIP messages are part of the voice session between the SIP Enabled Applications that are executing on the SIP Enabled Devices. The relative ordering of these messages is such that the “VOICE SESSION (13)” messages are sent between the “OK (11)” SIP message and the “BYE (14)” SIP message.

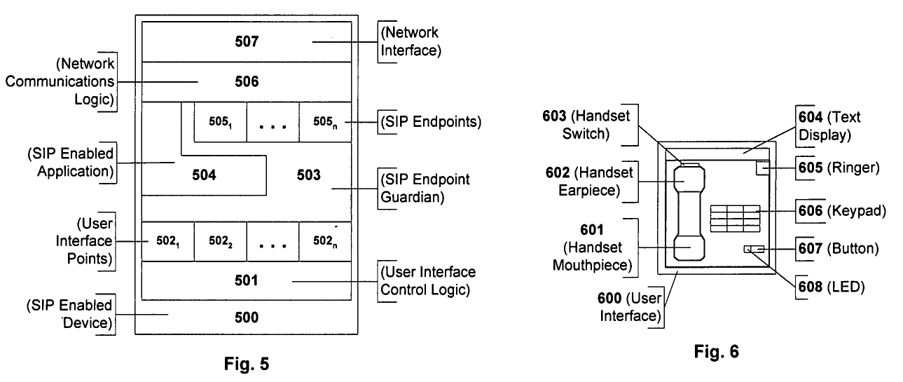

FIG. 5 depicts a block diagram of the SIP Enabled Device of the present invention. The present invention relates to a SIP Enabled Device 500 that is logically comprised of the elements shown. User Interface Control Logic 501 interfaces with a user interface (not shown) that a device user (not shown) interacts with to operate the device. The User Interface Control Logic 501 also interfaces with one or more User Interface Point (“UIP”) 502₁-502ₙ. A SIP Endpoint Guardian (“SEG”) 503 coordinates the activities of User Interface Points 502₁-502ₙ, a SIP Enabled Application 504, and a plurality of SIP Endpoints 505₁-505ₙ. The SEG 503 provides common services for the SIP Endpoints 505₁-505ₙ, including sending and receiving SIP messages (not shown). The SIP Enabled Application 504 employs the SEG 503 to simplify interactions with SIP Endpoints 505₁-505ₙ and User Interface Points 502₁-502ₙ.

The SIP Enabled Application 504 also interfaces with Network Communications Logic 506 to send and receive non-SIP messages (not shown). Network Communications Logic 506 implements communications protocols that are required to communicate with other network resources. The Network Communications Logic 506 interfaces with Network Interface 507, which is used to physically interface to a network that provides connectivity with other SIP Enabled Devices (not shown).

FIG. 6 shows a User Interface 600 of an exemplary SIP Enabled Device of the present invention. In this example, the User Interface 600 includes: handset mouthpiece 601, handset earpiece 602, handset switch 603, text display 604, ringer 605, keypad 606, a button 607, and a Light Emitting Diode (LED) 608. As will be described, button 607 and LED 608 are used to implement a new feature.

The following example is provided to illustrate the operation of the exemplary SIP Enabled Device of the present invention that is depicted in FIGS. 5 and 6. In this example, a SIP Enabled Device is used in an Internet telephony application that implements a callback feature. This callback feature allows a calling party to leave a short text message for a called party and allows the calling party to send an address where the called party should call the calling party back. When the called party receives such a callback request, callback LED 608 illuminates, which indicates to a user that a callback request has been received. When the called party presses callback button, the caller's text message and address are displayed on text display 604 of the device for a specified period of time. When the called party presses callback button 607 again, while the text message is still being displayed, a voice call is initiated to the address sent by the calling party during the callback session.

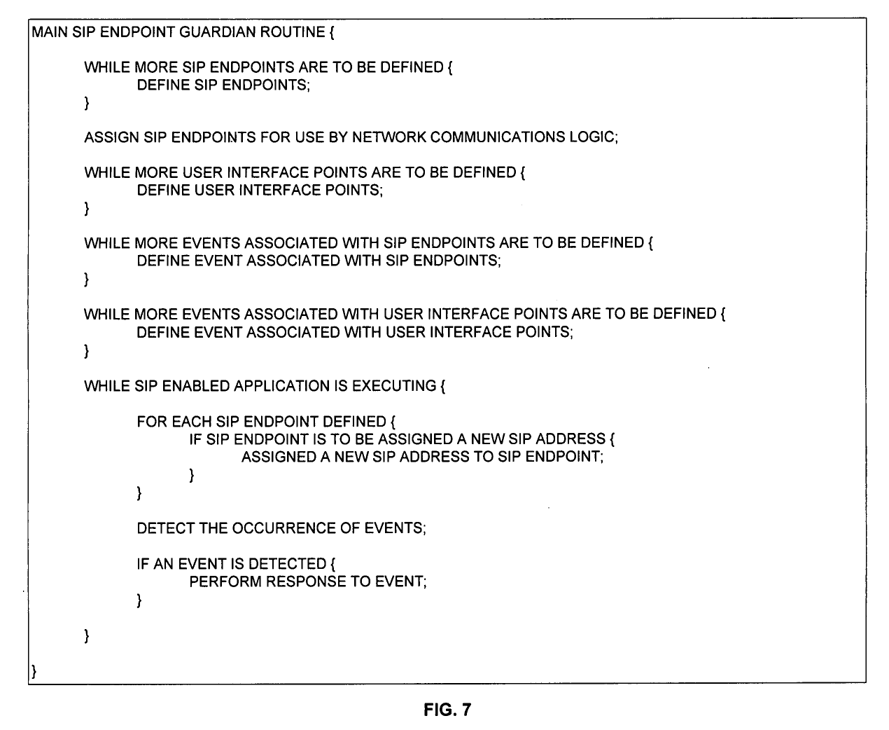

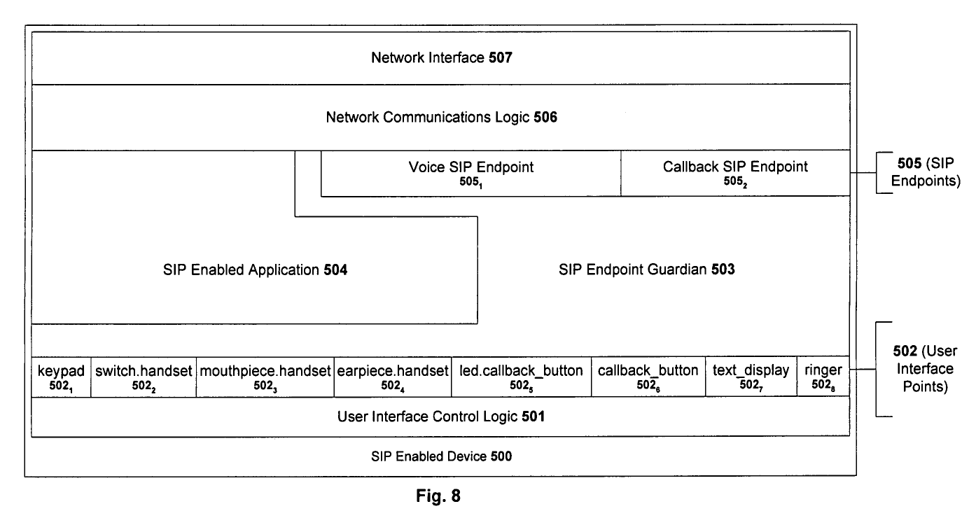

FIG. 7 depicts pseudo code showing the basic functionality of an exemplary SEG 503. The SIP Enabled Application 504 developer uses the SEG 503 to create the exemplary callback feature on the SIP Enabled Device 500. A block diagram of the resulting SIP Enabled Device is shown in FIG. 8.

As shown in FIG. 8, the developer first defines two SIP Endpoints 505, one for managing voice sessions, Voice SIP Endpoint 505₁, and a second for managing callback sessions, Callback SIP Endpoint 505₂. Next, the developer defines eight User Interface Points (“UIP”) 502 named: keypad 502₁, switch.handset 502₂, mouthpiece.handset 502₃, earpiece.handset 502₄, led.callback_button 502₅, callback_button 502₆, text_display 502₇, and ringer 502₈.

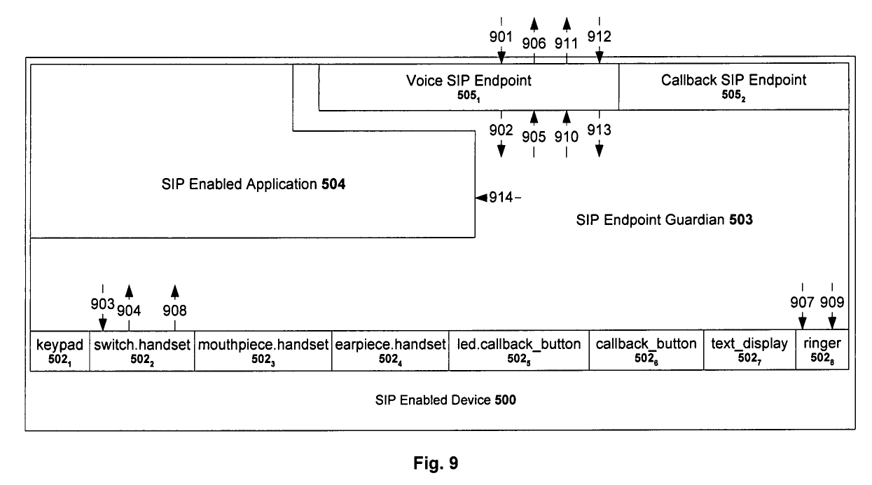

FIG. 9 shows the User Interface Points 502, SIP Endpoint Guardian 503, SIP Enabled Application 504, and SIP Endpoints 505 of the SIP Enabled Device 500 from FIG. 8. A few exemplary events and responses are shown in FIG. 9 to illustrate the operation of the SEG 503. After SIP Endpoints 505₁ and 505₂ are defined, they are assigned for use in Network Communications Logic 506. After defining the User Interface Points 502₁-502₈ and SIP Endpoints 505₁ and 505₂, the developer defines events for the User Interface Points 502 and SIP Endpoints 505.

In this example, a SIP “Invite” message, which corresponds to message 901, is received by the Voice SIP Endpoint 505₁. As a result, message 902 is sent to the SEG 503 indicating the arrival of the SIP “Invite” message. Next, the SEG 503 is programmed to determine if the device is currently in use. Message 903 is sent to the handset switch UIP 502₂, which sends message 904 to the SEG 503 indicating that the handset is on the switch. The SEG 503 then sends message 905 to the Voice SIP Endpoint 505₁, which causes a SIP “Ringing” message 906 to be sent to the sender of the SIP “Invite” message 901. The SEG 503 also responds by sending message 907 to the ringer UIP 502₈, which causes the ringer to ring. The SEG 503 also sets a logical timer (not shown). If the logical timer expires before a user picks up the handset, the SEG 503 will send another message to the ringer UIP 502₈ instructing the ringer to stop ringing.

In this example, the user answers the call by picking up the handset before the timer expires. The handset switch UIP 502₂ sends message 908 to the SEG 503, which indicates that the handset has been picked up and that the call has been answered. The SEG 503 responds by sending message 909 to the ringer UIP 502₈ instructing the ringer to stop ringing. The SEG 503 also responds by sending message 910 to the Voice SIP Endpoint 505₁, which causes the SIP “Ok” message 911 to be send from the Voice SIP Endpoint 505₁ to the sender of the SIP “Invite” message 901. The SEG 503 also sets a logical timer (not shown) so that an error message can be displayed if no SIP “Ack” message is received when the timer expires.

In this example, a SIP “Ack” message 912 is received on the Voice SIP Endpoint 505₁ before the logical timer expires, which sends message 913 to the SEG 503. When SEG 503 detects this event, it sends message 914 to the SIP Enabled Application 504, with information about the voice call session that has just been established.

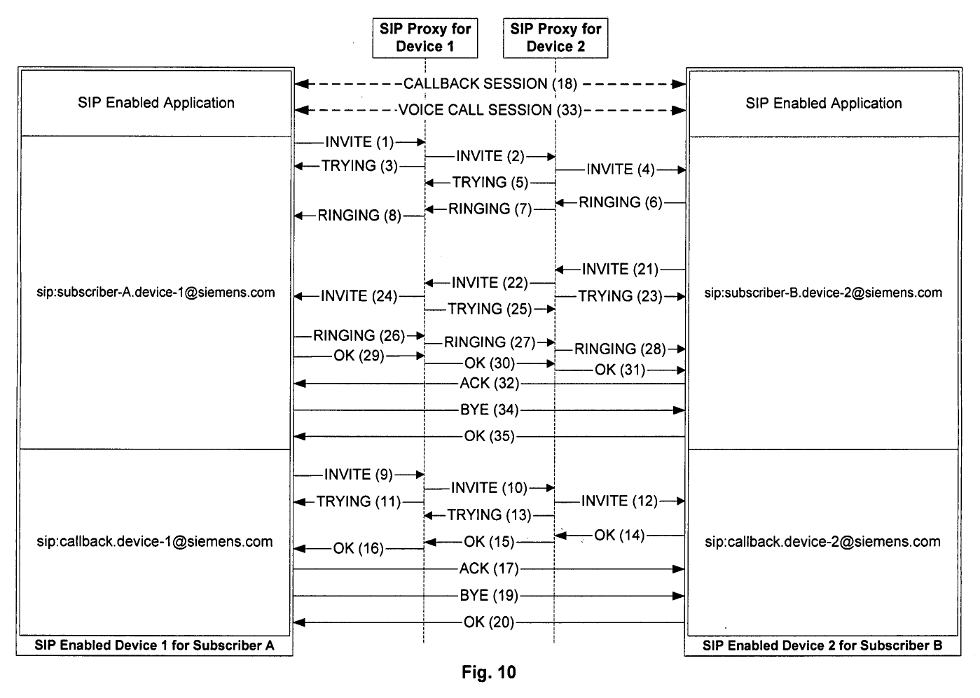

FIG. 10 depicts exemplary SIP messages that are exchanged when two of the SIP Enabled Devices of FIG. 8 are connected to the network of FIG. 3. For illustrative simplicity, only the SIP Enabled Applications and SIP Endpoints are shown. The same diagrammatic conventions that were used in FIG. 4 are used in FIG. 10. In this example, subscriber A uses SIP Enabled Device 1 to call subscriber B at SIP Enabled Device 2. Subscriber B does not answer the phone so subscriber A uses the callback feature to leave a callback request. Subscriber B then uses the callback function to return subscriber A's call. It should be noted that not every event, detection, and response will be described in the following discussion; only those that illustrate particular aspects of the operation of this exemplary embodiment of the present invention.

In this example, Device 1 and Device 2 are identically configured, except the SIP addresses assigned to the SIP Endpoints. The Voice SIP Endpoint and Callback SIP Endpoint on Device 1 are assigned the values “sip:subscriber-A.device-1@siemens.com” and “sip:callback.device-1@siemens.com” respectively. Similarly, the SIP Endpoints in Device 2 are assigned the values of “sip:subscriber-B.device-2@siemens.com” and “sip:callback.device-2@siemens.com.”

Initially, subscriber A picks up the handset on Device 1 and uses the keypad to enter the address for subscriber B. The SEG 503 and the SIP Enabled Application 504 executing on Device 1 have been programmed with the necessary events associated with the handset switch and keypad so that it can be detected when the user has picked up the handset and finished entering the destination address. In response to detecting the completion of these events, the “INVITE (1)” SIP message is sent from the Voice SIP Endpoint of Device 1.

New events are also defined for the Voice SIP Endpoint on Device 1, when the “INVITE (1)” SIP message is sent. One such event is to set a logical timer that is associated with the “INVITE (1)” SIP message. Another event that is defined is the receipt of a SIP “Ringing” message. Another event that is defined is the receipt of a SIP “Ok” message. If the timer expires before a SIP “Ringing” message is received, an error message is displayed on the text display or played in the handset earpiece. If a SIP “Ringing” message is received but not followed by a SIP “Ok” message from the destination of the “INVITE (1)” SIP message, the user is prompted to invoke the callback feature.

Since the “RINGING (8)” SIP message is received by Device 1, but no corresponding SIP “Ok” message is received when the logical timer expires, subscriber A is prompted to determine if she desires to use the callback function. For example, the SEG 503 sends a message to the handset earpiece UIP 502₄, which instructs the earpiece of the handset to play a pre-recorded message asking the user of the device to press the callback button if she would like to use the callback feature.

After subscriber A indicates that she desires to use the callback feature by pressing the callback button, she uses her keypad to compose a text message and then presses the callback button again to initiate the callback request. The SEG 503 monitors the keypad UIP 502₁ and the callback button UIP 502₆ to gather the text entered and to detect when the callback button is pressed again, which indicates that subscriber A has finished entering her text message and return address to use for the callback. When this event is detected by SEG 503, the “INVITE (9)” SIP message is sent from the Callback SIP Endpoint 505₂ in Device 1 to the Callback SIP Endpoint 505₂ in Device 2.

An event has been defined on Device 2 that corresponds to a successful transfer of Callback Data. When the “BYE (19)” SIP message is received by the Callback SIP Endpoint 505₂ on Device 2, this event is detected. A response is performed which sends a message to the callback LED button UIP 502₅ instructing the callback LED to illuminate, which indicates to a user of Device 2 that a callback request has been received. Another response is to define an event for the callback button UIP 502₆, which corresponds to the depression of the callback button while the LED of the callback button is in an illuminated state.

When subscriber B sees the illuminated LED and presses the callback button on Device 2, these events are detected and in response the callback return address and text message are sent to the text display UIP 502₇. This causes the return address and text message to be displayed on the text display of the user interface of Device 2 for a specified period of time. When the user presses that callback button again, which indicates that the user would like to initiate a voice call to the callback address, this event is detected. In response, the “INVITE (21)” SIP message is sent from the Voice SIP Endpoint 505₁ on Device 2, which initiates a voice call session with subscriber A at Device 1. The appropriate detections, responses, and new events are defined so that “VOICE CALL SESSION (33)” is completed.

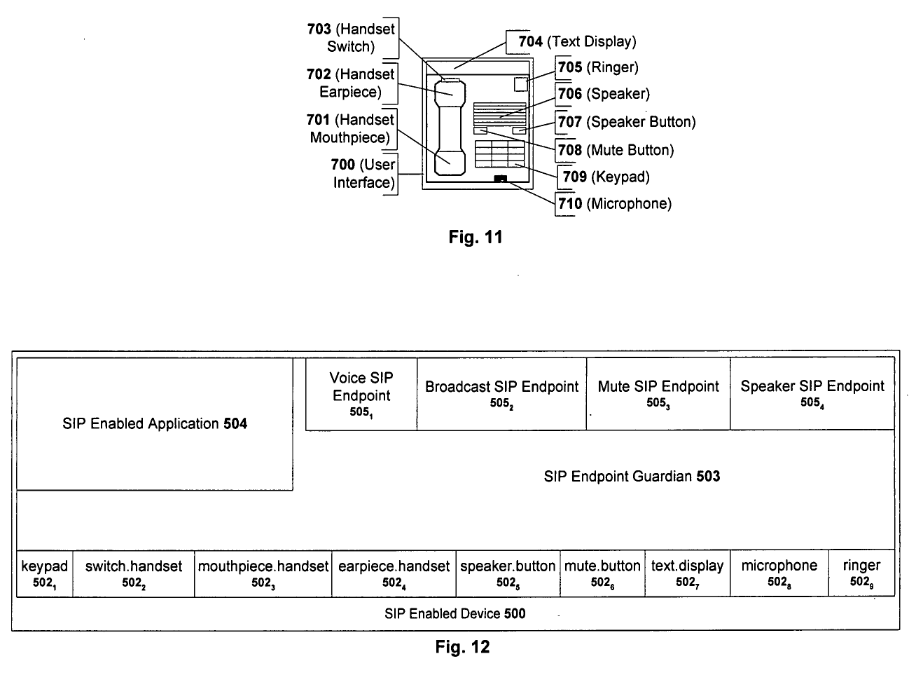

FIG. 11 depicts the User Interface 700 of another exemplary embodiment of the SIP Enabled Device of the present invention. User Interface 700 includes: handset mouthpiece 701, handset earpiece 702, handset switch 703, text display 704, ringer 705, speaker 706, speaker button 707, mute button 708, keypad 709, and microphone 710.

FIG. 12 depicts a block diagram of the SIP Enabled Device 500, whose User Interface 700 is depicted in FIG. 11. Only the User Interface Points 502₁-502₈, SIP Endpoint Guardian 503, SIP Enabled Application 504, and SIP Endpoints 505₁-505₄ are shown. In this example, nine User Interface Points 502 have been defined: keypad 502₁, handset switch 502₂, handset mouthpiece 502₃, handset earpiece 502₄, speaker button 502₅, mute button 502₆, text display 502₇, microphone 502₈, and ringer 502₉. Four SIP Endpoints 505 have also been defined and assigned for use: Voice SIP Endpoint 505₁, Broadcast SIP Endpoint 505₂, Mute SIP Endpoint 505₃, and Speaker SIP Endpoint 505₄.

In this example, a one-way voice broadcast feature has been implemented in the SIP Enabled Device 500 that is depicted in FIG. 12. When SIP Enabled Device 500 is contacted on the Broadcast SIP Endpoint 505₂ to participate in a one-way broadcast session, it first responds indicating if SIP Enabled Device 500 is going to participate in the one-way broadcast. If the contacted SIP Enabled Device 500 indicates that it will participate in the one-way voice broadcast, then the originator responds by sending SIP messages to the Mute SIP Endpoint 505₃ and to the Speaker SIP Endpoint 505₄, which causes the speaker and mute to activate. Once the receiver's speaker and mute are activated, a voice session is established using the Voice SIP Endpoint 505₁.

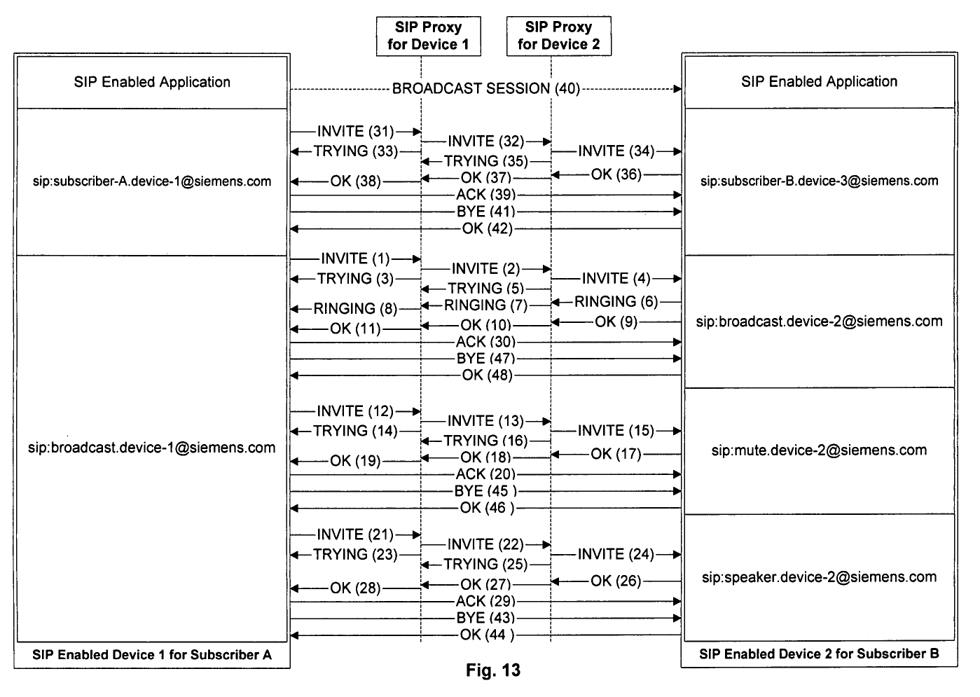

FIG. 13 depicts exemplary messages that are exchanged when two of the SIP Enabled Devices that are depicted in FIG. 12 are connected to the network of FIG. 3. The same diagrammatic conventions that were used in FIG. 4 are used in FIG. 13. Once again in the discussion that follows, not all events, detections, and responses will be described. Only aspects of the one-way broadcast session that demonstrate particular features of the present invention will be described.

Initially, the Broadcast SIP Endpoint 505₂ on Device 1 sends the “INVITE (1)” SIP message to the Broadcast SIP Endpoint 505₂ on Device 2. When the SEG 503 on Devices 2 detects the event of receiving the “INVITE(4)” SIP message, it responds by sending the “RINGING (6)” SIP message to the Broadcast SIP Endpoint 505₂ on Device 1, which indicates that Device 2 may be willing to participate in the one-way broadcast session. The SEG 503 on Device 2 instructs the Broadcast SIP Endpoint 505₂ to send the “OK (9)” SIP message, which indicates that Device 2 will participate in the one-way broadcast.

The SEG 503 on Device 1 detects the “OK (11)” SIP message. In response, the SEG 503 on Device 1 causes the “INVITE (12)” SIP message to be sent, with auto answer enabled, to the Mute SIP Endpoint 505₃ on Device 2. The SEG 503 on Device 2 responds by sending a message to the mute button UIP 502₆, which prevents the microphone from functioning. The SEG 503 on Device 2 also responds by sending the “OK (17)” SIP message.

Similarly, the SEG 503 on Device 1 causes the “INVITE (21)” SIP message to be sent, with auto answer enabled, to the Speaker SIP Endpoint 505₄ on Device 2. The SEG 503 on Device 2 responds by sending a message to the speaker button UIP 502₅, which activates the speaker. The SEG 503 on Device 2 also responds by sending the “OK (26)” SIP message.

When the SEG 503 on Device 1 detects the “Ok” SIP messages from the Speaker and Mute SIP Endpoints on Device 1, it responds by sending the “ACK (20)” SIP message, the “ACK (29)” SIP message, and the “ACK (30)” SIP message to Device 2. The SEG 503 on Device 1 also responds by setting up a voice call, by sending the “INVITE (31)” SIP message from the Voice SIP Endpoint 505₁ on Device 1 to the Voice SIP Endpoint 505₁ on Device 2.

Once the voice session is set up, “BROADCAST SESSION (40)” data is sent from the SIP Enabled Application 504 on Device 1 to the SIP Enabled Application 504 on Device 2. When the user of Device 1 instructs Device 1 to end the one-way broadcast, Device 1 sends a series of SIP “Bye” messages to Device 2. These messages correspond to the “BYE (41)” SIP message, the “BYE (43)” SIP message, the “BYE (45)” SIP message, and the “BYE (47)” SIP message. When the SEG 503 on Device 2 detects these SIP “Bye” messages, it returns Device 2 to its original state; the speaker is deactivated and the mute is disabled.

One skilled in the art will appreciate that many changes can be made to the exemplary embodiments disclosed without departing from the spirit of the present invention.

1. A method for Session Initiation Protocol (SIP) based communications comprising:
providing a plurality of SIP endpoints;
providing an SIP enabled device; and
assigning at least two of said plurality of SIP endpoints to said SIP enabled device.

2. The method of claim 1 further comprising:
defining a first event associated with at least one of said assigned SIP endpoints;
detecting an occurrence of said first event;
performing a first response upon detecting said occurrence of said first event.

3. The method of claim 2, wherein said first event is one of:
receiving an SIP message on at least one of said assigned SIP endpoints; or
an expiration of a logical timer.

4. The method of claim 2, wherein said response is one of:
sending at least one message from at least one of said assigned SIP endpoints;
defining a second event associated with at least one of said assigned SIP endpoints; or
setting a logical timer.

5. The method of claim 2, further comprising:
providing at least one user interface point;
defining a second event associated with one of said at least one user interface point;
detecting an occurrence of said second event;
performing a second response upon detecting said occurrence of said second event.

6. The method of claim 5, wherein said first response or said second response, is one of:
sending a message to one of said at least one user interface point; or
sending at least one SIP message from at least one of said assigned SIP endpoints.

7. An apparatus comprising:
a Session Initiation Protocol (SIP) enabled device suited to perform SIP based communications; and
a plurality of SIP endpoints, wherein at least two of said plurality of SIP endpoints are assigned to said SIP enabled device.

8. The apparatus of claim 7, wherein a first event associated with at least one of said assigned SIP endpoints is defined and upon detection of an occurrence of said first event, a first response is performed.

9. The apparatus of claim 8, wherein said first event is one of:
receiving at least one SIP message on at least one of said assigned SIP endpoints; or
an expiration of a logical timer.

10. The apparatus of claim 8, wherein said first response is one of:
sending at least one SIP message from at least one of said assigned SIP endpoints;
defining a second event associated with at least one of said assigned SIP endpoints; or
setting a logical timer.

11. The apparatus of claim 8 further comprising:
at least one user interface point, wherein a second event is defined, which is associated with one of said at least one user interface point, and upon detecting an occurrence of said second event, a second response is performed.

12. The apparatus of claim 11, wherein said first response or said second response is one of:
sending a message to one of said at least one user interface point; or
sending at least one SIP message from at least one of said assigned SIP endpoints.

13. A computer program product comprising a computer usable medium having computer readable program code embodied therein configured to:
communicate in Session Initiation Protocol (SIP) based communications using a plurality of SIP endpoints, wherein at least two of said plurality of SIP endpoints are assigned to a single SIP enabled device.

14. The computer program product of claim 13, wherein the computer readable program code is further configured to:
define a first event, which is associated with at least one of said assigned SIP endpoints;
detect an occurrence of said first event; and
perform a first response upon detecting said occurrence of said first event.

15. The computer program product of claim 14, wherein the computer readable program code is configured to define said first event that is one of:
receiving at least one SIP message on at least one of said assigned SIP endpoints; or
an expiration of a logical timer.

16. The computer program product of claim 14, wherein the computer readable program code is configured to perform said first response that is one of:
sending at least one SIP message from at least one of said assigned SIP endpoints;
defining a second event associated with at least one of said assigned SIP endpoints; or
setting a logical timer.

17. The computer program product of claim 14, wherein the computer readable program code is further configured to:
define a second event associated with one of said at least one user interface point;
detect an occurrence of said second event; and
perform a second response upon detecting said occurrence of said second event.

18. The computer program product of claim 17, wherein said first response or said second response is one of:
sending a message to one of said at least one user interface point; or
sending at least one SIP message from at least one of said assigned SIP endpoints.
